(19) United States
(12) Patent Application Publication
(10) Pub. No.: US 2022/0360079 A1
(43) Pub. Date: Nov. 10, 2022

(54) OPTIMAL POWER FLOW ACQUIRING METHOD FOR REGIONAL DISTRIBUTION NETWORK OF SMALL HYDROPOWER GROUPS BASED ON DEEP LEARNING

(71) Applicant: GUANGXI UNIVERSITY, Nanning (CN)

(72) Inventors: Xiaoqing BAI, Nanning (CN); Biyun CHEN, Nanning (CN); Yujing JIA, Nanning (CN); Bin LI, Nanning (CN); Peijie LI, Nanning (CN); Yun ZHU, Nanning (CN); Ge ZHANG, Nanning (CN); Yunyi LI, Nanning (CN); Tianyi DIAO, Nanning (CN); Guang LIU, Nanning (CN); Danlei CHEN, Nanning (CN); Shangfu WEI, Nanning (CN); Xian TANG, Nanning (CN); Liqin ZHENG, Nanning (CN); Xinwen WANG, Nanning (CN); Songyang ZHU, Nanning (CN); Zonglong WENG, Nanning (CN); Qinghua SHANG, Nanning (CN); Rui WANG, Nanning (CN); Puming WANG, Nanning (CN); Xiaoqing SHI, Nanning (CN)

(73) Assignee: GUANGXI UNIVERSITY, Nanning (CN)

(21) Appl. No.: 17/727,780

(22) Filed: Apr. 24, 2022

(30) Foreign Application Priority Data
Apr. 29, 2021 (CN) 202110471665.0

(51) Int. Cl. H02J 3/06; H02J 3/38; G06N 3/08

(52) U.S. Cl. CPC H02J 3/06; H02J 3/38; G06N 3/08; H02J 2300/40; H02J 2203/20

(57) ABSTRACT

Disclosed is an optimal power flow acquiring method for regional distribution network of small hydropower groups based on deep learning, which specifically includes the following steps: generating required data sets by adopting continuous power flow and power flow equation calculation methods; the data set is randomly divided into training data (80 percent) and test data (20 percent); training the built convolutional neural network model with training data to learn the mapping relationship between load and generator output power; inputting test data, and directly obtaining P_{G} and Q_{G} from the trained convolutional neural network; and solving residual variables Vᵢ and θᵢ with traditional power flow solver. The application can accelerate the solving speed of the optimal power flow problem with higher prediction accuracy.

### CROSS-REFERENCE TO RELATED APPLICATIONS

This application claims priority to Chinese Patent Application No. 202110471665.0, filed on Apr. 29, 2021, the contents of which are hereby incorporated by reference.

### TECHNICAL FIELD

The application relates to the technical field of power system operation optimization, and in particular to an optimal power flow acquiring method for regional distribution network of small hydropower groups based on deep learning.

### BACKGROUND

In areas rich in water resources, the construction scale and capacity of small hydropower are rapidly expanding, which has an important influence on saving electric energy and improving voltage quality in power sector. Small hydropower is mostly runoff, with a small capacity and poor adjustability. The output of hydropower is influenced by climate, rainfall and other factors. During the period of hydropower generation, a large number of online power trends greatly increase the load of some equipment, and the heavy-load operation of equipment will increase the risk of safe operation of power grid. In the dry season, the hydropower output is low, and the load in the near area needs to be dropped from the provincial grid channel, which leads to a long transmission distance and has s a lot of reactive loss. Therefore, the operation mode of the power grid in many small hydropower areas is complex and changeable, which is seriously affected by hydropower output. The optimal power flow model has nonlinear as well as non-convex characteristics, which is a complex linear programming problem, so it is difficult to calculate reliably and efficiently. The conventional linearization method can simplify the nonlinear power flow equation, but the conventional method may negatively affect the accuracy of the solution. Although the research has made some progress at present, the calculation efficiency of the optimal power flow is still a difficult problem. According to the characteristics of power grid operation, it is an important means to realize safe, economical and high-quality operation of power grid by the optimal power flow to solve the power optimization problem and comprehensively utilize various loss reduction schemes.

### SUMMARY

The objective of this application is to provide an optimal power flow acquiring method for regional distribution network of small hydropower groups based on deep learning, so as to solve the above-mentioned problems in the prior art and realize safe, economical and high-quality operation of power grids.

To achieve the above objective, the application provides the following scheme.

The application discloses an optimal power flow acquiring method for regional distribution network of small hydropower groups based on deep learning, which includes the following steps:

tracking the steady-state behavior of power system under load change and generator power change based on continuous power flow method, obtaining the steady-state behavior model of power system, and obtaining a node voltage amplitude and a phase angle based on the steady-state behavior model of power system;

obtaining load data by power flow equation calculation based on the node voltage amplitude and the phase angle;

on the basis of the load data, obtaining an accurate value P*_{G} of a generator active power and an accurate value Q*_{G} of a generator reactive power by a traditional optimal power flow solver;

constructing a convolutional neural network model, and integrating the load data, the generator active power and the generator reactive power into a first data set; dividing the first data set into training data and test data according to the ratio of 8:2, and training the convolutional neural network model based on the training data; and

predicting the generator active power and the generator reactive power based on the convolutional neural network model, and then obtaining a predicted value \hat{P}_{G} of the generator active power and a predicted value \hat{Q}_{G} of the generator reactive power; inputting the predicted active power of the generator, the predicted reactive power of the generator and the load data into a traditional power flow solver to obtain remaining variables \hat{V}, \hat{θ} of the optimal power flow solution; integrating the generator active power \hat{P}_{G}, the generator reactive power \hat{Q}_{G} and the remaining variables to form a solution of the optimal power flow.

Preferably, the steady-state behavior model of the power system includes:

f(x,λ)=0

0≤λ≤λ_{critical}

where f∈Rⁿ, x∈Rⁿ, λ∈R, R represents a one-dimensional space, Rⁿ represents a n-dimensional space, λ_{critical} represents a critical load, vector x contains amplitudes and phase angles of all bus voltages in the system, λ is a scalar parameter reflecting the load level of the system.

A basic load expression is:

P_{Li}=P_{Li(0)}+λ(k_{Li}S_{Δbase} cos φᵢ)

Q_{Li}=Q_{Li(0)}+Δ(k_{Li}S_{Δbase} sin φᵢ)

where P_{Li} and Q_{Li} respectively represent two basic loads of bus i; k_{Li} specifies the multiplier of the change rate of bus i load with λ surface; φᵢ is the power factor angle of bus i load change; S_{Δbase} is the apparent power with proper proportion of specified λ.

A generator active output correction P_{Gi} is:

P_{Gi}=P_{Gi(0)}+(1+λk_{Gi})

where P_{Gi(0)} is a basic active output of the generator of bus i; k_{Gi} is used to specify the constant of generator active output changing with λ.

Preferably, the function of training the convolutional neural network model based on the training data is to learn the mapping relationship between load and generator output power.

Preferably, the load data is obtained based on the power flow equation calculation method.

Preferably, the expression of the active power based on the power flow equation is:

$${P}_{i} = {V}_{i} {\sum }_{j = 1}^{n} {V}_{j} ( {B}_{i j} sin {θ}_{i j} + {G}_{i j} cos {θ}_{i j} ) ( i ∈ {S}_{B} )$$

where Pᵢ represents the active power of each bus; Vᵢ represents the voltage amplitude of bus i; Gᵢⱼ and Bᵢⱼ are the real part and imaginary part of the elements in the i-th row and j-th column of the node admittance matrix, respectively; S_{B} represents the set of all nodes in the system; θᵢⱼ=θᵢ−θⱼ, in which θᵢ represents the voltage phase angle of bus i.

Preferably, the expression of the reactive power based on the power flow equation is:

$${Q}_{i} = {V}_{i} {\sum }_{j = 1}^{n} {V}_{j} ( {B}_{i j} cos {θ}_{i j} - {G}_{i j} sin {θ}_{i j} ) ( i ∈ {S}_{B} )$$

where Qᵢ represents the reactive power of each bus, θᵢⱼ=θᵢ−θⱼ.

Preferably, the convolutional neural network adopts a 1-layer convolutional network.

The application discloses the following technical effects.

The application provides an efficient method for solving the optimal power flow of distribution network, which tracks the steady-state behavior of power system under the change of load and generator power by a continuous method to obtain bus voltage amplitude and phase angle data; load data are obtained by power flow equation calculation method. The application also adopts the convolutional neural network in deep learning, randomly divides the obtained data into training set and test set, trains the convolutional neural network to learn the mapping relationship between load and generator output power, and finally obtains the residual variables. The application could accelerate the solving speed of the optimal power flow problem, and has higher prediction accuracy.

### BRIEF DESCRIPTION OF THE DRAWINGS

In order to more clearly illustrate the embodiments in this application or the technical solutions in the prior art, the following will briefly introduce the drawings needed in the embodiments. Obviously, the drawings in the following description are only some examples of this application, and for those of ordinary skill in this field, other drawings could be obtained according to these drawings without creative efforts.

FIG. 1 is a schematic diagram of continuous power flow calculation process.

FIG. 2 is a schematic diagram of ConvOPF's frame structure.

FIG. 3 is a schematic diagram of the comparison between the predicted value of ConvOPF and the exact solution.

### DETAILED DESCRIPTION OF THE EMBODIMENTS

Now various exemplary embodiments of this application will be described in detail. This detailed description should not be considered as a limitation of this application, but should be understood as a more detailed description of some aspects, characteristics and embodiments of this application.

It should be understood that the terminology used in this application is only for describing specific embodiments, rather than limiting this application. In addition, for the numerical range in this application, it should be understood that every intermediate value between the upper limit and the lower limit of the range is also specifically disclosed. Any stated value or intermediate value within the stated range and any other stated value or every smaller range between intermediate values within the stated range are also included in this application. The upper and lower limits of these smaller ranges could be independently included or excluded from the range.

Unless otherwise specified, all technical and scientific terms used herein have the same meaning as commonly understood by those of ordinary skill in the field to which this application belongs. Although this application only describes the preferred methods and materials, any methods and materials similar or equivalent to the descriptions herein can also be used in the implementation or testing of this application. All documents mentioned in this description are incorporated by reference to disclose and describe the methods and/or materials related to the documents. In case of conflict with any incorporated documents, the contents of this description shall prevail.

Without departing from the scope or spirit of this application, it is obvious to those of ordinary skill in the art that many improvements and changes could be made to the specific embodiments of this application. Other embodiments obtained from the specification of this application will be obvious to the skilled person. The specification and examples of this application are exemplary only.

The words “include”, “comprise”, “have” and “contain” used in this paper are all open terms and mean including but not limited to.

Unless otherwise specified, “part” mentioned in this application is calculated by parts by mass.

### Embodiment 1

The application provides an optimal power flow acquiring method for regional distribution network of small hydropower groups based on deep learning, which includes the following steps:

tracking the steady-state behavior of power system under load change and generator power change based on continuous power flow method, obtaining a steady-state behavior model of power system, and obtaining a node voltage amplitude and a phase angle based on the steady-state behavior model of power system;

obtaining load data by power flow equation calculation on the basis of the node voltage amplitude and the phase angle;

obtaining an accurate value P*_{G} of a generator active power and an accurate value Q*_{G} of a generator reactive power by the conventional optimal power flow solver on the basis of the load data;

constructing a convolutional neural network model, and integrating the load data, the generator active power and the generator reactive power into a first data set; dividing the first data set into training data and test data according to the ratio of 8:2, and training the convolutional neural network model based on the training data;

based on the convolutional neural network model, predicting the active power and reactive power of the generator to obtain a predicted value \hat{P}_{G} of the active power and a predicted value \hat{Q}_{G} of the reactive power of the generator; inputting the predicted active power of the generator, the predicted reactive power of the generator and the load data into a traditional power flow solver to obtain the remaining variables \hat{V}, \hat{θ} of the optimal power flow solution; integrating the generator active power \hat{P}_{G}, the generator reactive power \hat{Q}_{G} and the remaining variables to form a solution of the optimal power flow.

Further, the method for obtaining the power flow solution path changing with the load is as follows: based on the known load value, the tangent predictor is used to estimate the value in the specified load increasing mode as an estimated value, and the estimated value is corrected by the conventional power flow program under the fixed load to obtain the accurate solution.

Further, the steady-state behavior model of the power system includes:

f(x,λ)=0

0≤λ≤λ_{critical}

where f∈Rⁿ, x∈Rⁿ, λ∈R, R represents one-dimensional space, Rⁿ represents n-dimensional space, λ_{critical} represents critical load, vector x contains the amplitude and phase angle of all bus voltages in the system, λ is a scalar parameter reflecting the load level of the system.

A basic load expression is:

P_{Li}=P_{Li(0)}+λ(k_{Li}S_{Δbase} cos φᵢ)

Q_{Li}=Q_{Li(0)}+Δ(k_{Li}S_{Δbase} sin φᵢ)

where P_{Li} and Q_{Li} respectively represent two basic loads of bus i; k_{Li} specifies the multiplier of the change rate of bus i load with λ surface; φᵢ is the power factor angle of bus i load change; S_{Δbase} is the apparent power with proper proportion of specified λ.

The generator active output correction P_{Gi} is:

P_{Gi}=P_{Gi(0)}+(1+λk_{Gi})

where P_{Gi(0)} is the basic active output of the generator of bus i; k_{Gi} is used to specify the constant of generator active output changing with λ.

Further, training the convolutional neural network model based on the training data has the function of learning the mapping relationship between load and generator output power.

Further, the load data is obtained based on the power flow equation calculation method.

Further, the expression of the active power based on the power flow equation is:

$${P}_{i} = {V}_{i} {\sum }_{j = 1}^{n} {V}_{j} ( {B}_{i j} sin {θ}_{i j} + {G}_{i j} cos {θ}_{i j} ) ( i ∈ {S}_{B} )$$

where Pᵢ represents the active power of each bus; Vᵢ represents the voltage amplitude of bus i; Gᵢⱼ and Bᵢⱼ are the real part and imaginary part of the elements in the i-th row and j-th column of the node admittance matrix, respectively; S_{B} represents the set of all nodes in the system; θᵢⱼ=θᵢ−θⱼ, in which θᵢ represents the voltage phase angle of bus i.

Further, the expression of the reactive power based on the power flow equation is:

$${Q}_{i} = {V}_{i} {\sum }_{j = 1}^{n} {V}_{j} ( {B}_{i j} cos {θ}_{i j} - {G}_{ij} sin {θ}_{i j} ) ( i ∈ {S}_{B} )$$

where Qᵢ represents the reactive power of each bus, θᵢⱼ=θᵢ−θⱼ.

Further, the convolutional neural network adopts a one-layer convolutional network.

### Embodiment 2

As shown in FIG. 2, ConvOPF model includes three stages: data generation stage, training stage and testing stage.

(1) Data Generation Stage

To train the convolutional neural network model, it is necessary to obtain training data first. ConvOPF adopts continuous power flow and power flow equation calculation method to generate load data.

Firstly, the node voltage amplitude Vᵢ and phase angle θᵢ are generated by the continuous power flow method. Continuation Method is the basic method to track the solution curve of nonlinear algebraic equations with the change of parameters. Continuous power flow adopts continuous method to track the steady-state behavior of power system under load and generator power change. The mathematical model of steady-state behavior of power system is as follows:

f(x,λ)=0

0≤λ≤λ_{critical}

where f∈Rⁿ, x∈Rⁿ, λ∈R, vector x contains the amplitudes and phase angles of all bus voltages in the system, λ is a scalar parameter reflecting the load level of the system.

P_{Li}=P_{Li(0)}+λ(k_{Li}S_{Δbase} cos φᵢ)

Q_{Li}=Q_{Li(0)}+Δ(k_{Li}S_{Δbase} sin φᵢ)

where P_{Li} and Q_{Li} respectively represent the basic load of bus i; k_{Li} specifies the multiplier of the change rate of bus i load with λ surface; φᵢ is the power factor angle of bus i load change; S_{Δbase} is the apparent power with a proper proportion of λ. In addition, the active output of the generator is revised as follows:

P_{Gi}=P_{Gi(0)}+(1+λk_{Gi})

where P_{Gi(0)} is the basic active output of the generator of bus i; k_{Gi} is used to specify the constant of generator active output changing with λ.

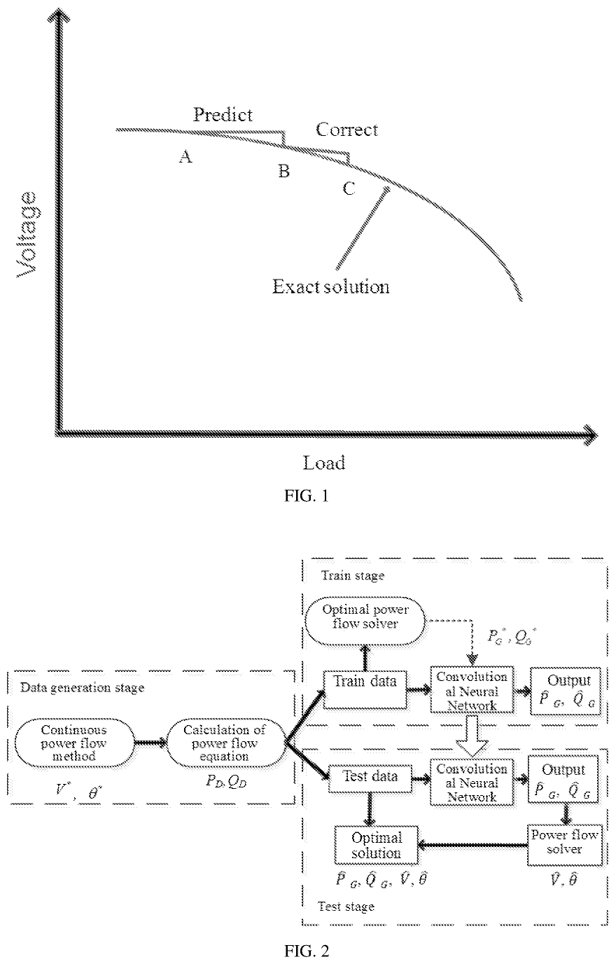

The continuous power flow adopts the prediction-correction scheme to find out the power flow solution path changing with the load parameters. As shown in FIG. 1, starting from the known basic solution A, the tangent predictor is used to estimate the solution B under the specified load increase mode. Then, under the fixed load, the accurate solution C can be obtained by correcting the estimated value with the conventional power flow program.

By setting some parameters in continuous power flow calculation, the convergence of the optimal power flow calculation results of the obtained data could be ensured.

The core idea of the power flow calculation method is to obtain the load data (P_{D}, Q_{D}) by taking the node voltage amplitude and phase angle as the conditions of power flow solution. The active power and reactive power of each bus are described by the nonlinear power flow equation (14).

$$\{ \begin{matrix}{P}_{i} = {V}_{i} {\sum }_{j = 1}^{n} {V}_{j} ( {B}_{i j} sin {θ}_{i j} + {G}_{i j} cos {θ}_{i j} ) \\ {Q}_{i} = {V}_{i} {\sum }_{j = 1}^{n} {V}_{j} ( {B}_{i j} cos {θ}_{i j} + {G}_{i j} sin {θ}_{i j} )\end{matrix} ( i ∈ {S}_{B} )$$

where Pᵢ and Qᵢ represent the active and reactive power of each bus; θᵢⱼ=θᵢ−θⱼ.

After obtaining P_{D} and Q_{D}, the load data are randomly divided into training data and test data. Then the load data is input into the conventional optimal power flow solver to generate P*_{G} and Q*_{G} in training data and test data.

(2) Convolutional Neural Network Model

Convolutional neural network model is the core of ConvOPF, which is used to approximate the mapping relationship between load and generator output power. Designing a 1-layer convolutional network. According to observation, the detailed parameters of convolutional neural network model parameters are shown in Table 1.

TABLE 1

| Layer | Name |
|---|---|
| 1 | Convolutional layer |
| 2 | Flatten layer |
| 3 | Dense layer |
| 4 | Dense layer |

In order to get the voltage amplitude and phase angle of each node in the optimal solution, it is necessary to integrate the load data in the test stage with the active and reactive power data of the generator predicted by the convolutional neural network model. Then the integrated data is sent to the traditional power flow solver for calculation, and the corresponding residual variables Vᵢ and θᵢ are obtained.

### Embodiment 3

The application will be described in detail below with reference to the attached drawings. FIG. 2 is the frame structure of ConvOPF model. The application provides an optimal power flow acquiring method for regional distribution network of small hydropower groups based on deep learning, which mainly calculates the optimal power flow through the constructed ConvOPF model. In this application, the mapping relationship between the load input of optimal power flow and the active output of generator is studied by convolutional neural network, and then the corresponding voltage amplitude and phase angle are obtained by the traditional alternating current power flow solver. The method mainly includes the following steps:

(1) adopting continuous power flow and power flow equation calculation method to generate a required data set;

(2) dividing the data set randomly into a training data (80%) and a test data (20%);

(3) training the built convolutional neural network model with training data to learn the mapping relationship between load and generator output power;

(4) inputting test data and directly obtaining \hat{P}_{G} and \hat{Q}_{G} by the trained convolutional neural network; and

(5) solving residual variables \hat{V} and \hat{θ} with traditional power flow solver.

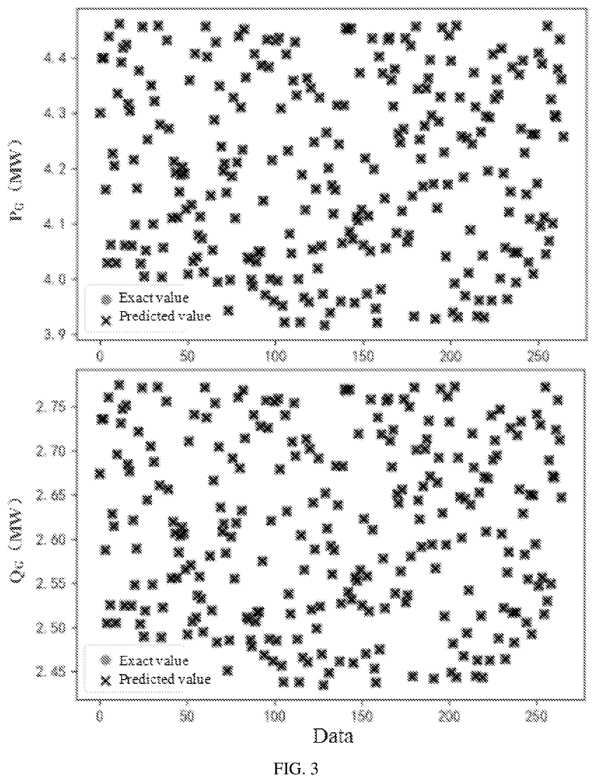

(6) comparing the predicted value (\hat{P}_{G}, \hat{Q}_{G}) and the accurate value (P*_{G}, Q*_{G}) of the active and reactive power of the generator, the result is shown in FIG. 3.

The above-mentioned embodiments only describe the preferred mode of this application, and shall not limit the scope of this application. Without departing from the design spirit of this application, all kinds of modifications and improvements made by those of ordinary skill in this field to the technical scheme of this application should fall within the protection scope determined by the claims of this application.

What is claimed is:

1. An optimal power flow acquiring method for a regional distribution network of small hydropower groups based on deep learning, comprising the following steps:
tracking a steady-state behavior of a power system under load change and generator power change based on a continuous power flow method, obtaining a steady-state behavior model of a power system, and obtaining a node voltage amplitude and a phase angle based on the steady-state behavior model of the power system;
obtaining load data by power flow equation calculation based on the node voltage amplitude and the phase angle;
obtaining an accurate value P*_{G} of a generator active power and an accurate value Q*_{G} of a generator reactive power by a conventional optimal power flow solver on the basis of the load data;
constructing a convolutional neural network model, and integrating the load data, the generator active power and the generator reactive power into a first data set; dividing the first data set into training data and test data according to the ratio of 8:2, training the convolutional neural network model based on the training data; and
predicting the generator active power and the generator reactive power based on the convolutional neural network model, and then obtaining a predicted value of the generator active power \hat{P}_{G} and a predicted value of the generator reactive power \hat{Q}_{G}; inputting the predicted active power of the generator, the predicted reactive power of the generator and the load data into a conventional power flow solver to obtain remaining variables of an optimal power flow solution; integrating the generator active power \hat{P}_{G}, the generator reactive power \hat{Q}_{G} and the remaining variables to form a solution of the optimal power flow;
wherein the steady-state behavior model of the power system comprises:
f(x,λ)=0
0≤λ≤λ_{critical}
wherein f∈Rⁿ, x∈Rⁿ, λ∈R, R represents a one-dimensional space, Rⁿ represents an n-dimensional space, λ_{critical} represents a critical load, vector x contains the amplitude and phase angle of all bus voltages in the system, λ is a scalar parameter reflecting the load level of the system;
a basic load expression is:
P_{Li}=P_{Li(0)}+λ(k_{Li}S_{Δbase} cos φᵢ)
Q_{Li}=Q_{Li(0)}+Δ(k_{Li}S_{Δbase} sin φᵢ)
wherein P_{Li} and Q_{Li} respectively represent two basic loads of bus i; k_{Li} specifies a multiplier of a change rate of bus i load with λ surface; φᵢ is a power factor angle of bus i load change; S_{Δbase} is an apparent power with a proper proportion of specified λ;
a generator active output correction P_{Gi} is:
P_{Gi}=P_{Gi(0)}+(1+λk_{Gi})
wherein P_{Gi(0)} is basic active output of the generator of bus i; k_{Gi} is used to specify a constant of generator active output changing with λ;
the expression of the active power based on the power flow equation is:
$${P}_{i} = {V}_{i} {\sum }_{j = 1}^{n} {V}_{j} ( {B}_{i j} sin {θ}_{i j} + {G}_{i j} cos {θ}_{i j} ) ( i ∈ {S}_{B} )$$
wherein Pᵢ represents the active power of each bus; Vᵢ represents the voltage amplitude of bus i; Gᵢⱼ and Bᵢⱼ are the real part and imaginary part of the elements in the i-th row and j-th column of the node admittance matrix, respectively; S_{B} represents the set of all nodes in the system; θᵢⱼ=θᵢ−θⱼ, in which θᵢ represents the voltage phase angle of bus i;
the expression of the work power based on the power flow equation is:
$${Q}_{i} = {V}_{i} {\sum }_{j = 1}^{n} {V}_{j} ( {B}_{i j} cos {θ}_{i j} - {G}_{i j} sin {θ}_{i j} ) ( i ∈ {S}_{B} )$$
wherein Qᵢ represents the reactive power of each bus, θᵢⱼ=θᵢ−θⱼ.

2. The optimal power flow acquiring method according to claim 1, wherein a function of training the convolutional neural network model based on the training data is to learn a mapping relationship between load and generator output power.

3. The optimal power flow acquiring method according to claim 1, wherein the load data is obtained based on a power flow equation calculation method.

4. The optimal power flow acquiring method according to claim 1, wherein the convolutional neural network adopts a 1-layer convolutional network.
